(19) United States
(12) Patent Application Publication
(10) Pub. No.: US 2003/0233309 A1
(43) Pub. Date: Dec. 18, 2003

(54) System and method for providing financial instrument trading information and for trading a financial instrument

(76) Inventors: George Matus, Allen, TX (US); Brian Todd Yakman, Allen, TX (US); Scott Leonard Heber, Allen, TX (US)

Correspondence Address: Raffi Gostanian, Jr., Jackson Walker L.L.P., Suite 600, 2435 North Central Expressway, Richardson, TX, 75080, US

(21) Appl. No.: 10/171,918

(22) Filed: Jun. 14, 2002

(51) Int. Cl. G06F 17/60

(52) U.S. Cl. 705/37

(57) ABSTRACT

The present invention provides a system and method for providing financial instrument trading information and for trading a financial instrument which includes receiving an identifier related to the financial instrument, simultaneously providing values related to the identifier and to a user's account information, receiving trade data related to the identifier, and simultaneously providing at least one complete trade scenario based on the identifier, a portion of the values, the user's account information, the received trade data, and a portion of the at least one trade scenario.

### FIELD OF THE INVENTION

The present invention relates to a financial instrument trading system and method and, more particularly, to a system and method for providing financial instrument trading information and for trading a financial instrument.

### BACKGROUND OF THE INVENTION

Traditional systems and methods for trading a financial instrument (such as, for example, a stock, a bond, an option, a mutual fund, etc.) and for receiving financial instrument trading information (such as, for example, the price of the financial instrument or the buying power associated with the financial instrument) involve the placing of a an order by a user via a plurality of interfaces such as an on-line broker, a telephone while communicating to a human broker, a telephone while navigating a menu via a keypad, or via a voice recognition system. On-line trading has been very popular because of its ease of use and typically lower commission expenses. Most financial instruments can be traded on-line and trading information relating to such financial instruments are typically available on-line.

Many on-line brokers such as Schwab, Ameritrade, and E-Trade, tout their ability to process a user's on-line trade within a short amount of time. It should be noted that the term “trade” as used herein refers to an on-line trade of a financial instrument unless otherwise stated. A few seconds after executing a trade, most of the on-line brokers guarantee that the trade (or order) will be routed to a marketplace (such as the New York Stock Exchange, the National Association of Securities Dealers Automated Quotation System, or an electronic communication network) and get executed (or filled). On-line brokers typically make such guarantees in order to convince the user that the financial instrument trade is being executed at the most recent price (for equities, the bid or the ask depending on whether the user is selling or buying the equity). Delays in executing the trade could alter the price of the equity and fill the trade at a price that would have otherwise caused the user to not trade the financial instrument. Only after an on-line broker receives information regarding the trade (the order) can the expedited execution of the trade begin. Such executions occur on the “back-end” of the on-line broker's network where the on-line broker's equipment can receive the user's order and submit it to a marketplace where it is filled. Confirmation of the filled order may be provided at nearly the same time or a short time thereafter.

While the speed of such “back-end” executions is important, there has been an oversight by such on-line (and traditional) brokers with regard to the “front-end” of a transaction which includes the actions taken by the user prior to the execution of the trade. Such “front-end” actions, which include inputting financial instrument information and trading information, can be difficult to understand and take a large amount of time to input. For example, after logging on to an on-line broker's web site, a symbol representing the financial instrument (for example, an equity) is inputted and information regarding the symbol is presented. Such information typically includes the last price, the change in price, the bid price, the ask price, and the trading volume of the symbol. The information may further include the time the symbol was input, the direction the stock price is moving (up, down, or neutral), the exchange the symbol is traded on, symbol lookup information, and performance charts.

In order to determine the amount of shares of the equity that can be purchased, or to determine the number of shares of the equity already owned that can be sold, other web pages of the on-line broker may be accessed. For example, a “balances” web page may provide information relating to available funds, buying power, margin purchase power, long marginable value, short marginable value, cash balance, margin balance, short balance, equity balance, equity percentage, maintenance requirement, and liquidation value. Further, a “positions” web page may provide information relating to financial instrument long positions, short positions, a quantity related to each of the positions, a market value related to each of the positions, and an overall portfolio market value. Also, to trade using margin, another web page may provide information regarding the margin requirement of a financial instrument. Such margin requirements may differ depending on the financial instrument or may not be applicable because the financial instrument may not be traded using margin.

Certain limitations exist in accessing these various on-line broker web pages. For example, after these web pages are accessed, the user can attempt to ascertain the number of shares that can be traded based on the amount of available cash, the margin purchase power, day trading purchase power, or margin requirements. Additionally, the commission charged to the user for executing the trade may differ based on the quantity ordered. In order to trade the equity, the user would typically re-input the quote to receive updated information regarding the symbol and would then calculate the number of shares that can be purchased based on the amount of available cash, the margin purchase power, the margin requirements, and the commission. Such calculations may consume a large amount of time and may need to be re-calculated if the financial instrument is experiencing a rapidly changing price due to high volatility. Further, any result of the calculations would not be based on real-time (or near real-time) data and thus a trade could not be placed based on the most updated available information. After a trade is placed, the potential of the trade to be denied at some later time (and often without the immediate awareness of the user) exists because the user may not have had enough cash or margin purchase power to trade the wanted number of shares. Even if the user had calculated the possible number of shares that could be traded, errors in such calculations would result in an incorrect number of tradable shares resulting in a denial of the trade or in an undesirable amount of traded shares.

Other limitations exist with regard to “front-end” actions. For example, the user may incorrectly input financial instrument and trading information and would not realize these errors have occurred until the order is executed or typically, until after the order is executed. Such errors include attempting to sell a financial instrument that the user does not own, attempting to sell a greater amount of shares than are currently owned, or attempting to purchase (via margin, for example) a greater amount of shares than is possible.

It is therefore desirable for the present invention to overcome the limitations described above that are involved in providing financial instrument trading information and for trading a financial instrument.

### SUMMARY OF THE INVENTION

The present invention achieves technical advantages as a system and method for providing financial instrument trading information and for trading a financial instrument. In one embodiment, a method for providing financial instrument trading information is provided. The method comprises receiving an identifier related to the financial instrument, simultaneously providing values related to the identifier and to a user's account information, receiving trade data related to the identifier, and simultaneously providing at least one complete trade scenario based on the identifier, a portion of the values, the user's account information, the received trade data, and a portion of the at least one trade scenario.

In another embodiment, a system for trading a financial instrument is provided. The system comprises a financial institution module, a user account located at the financial institution module, a user interface adapted to access the user account, wherein the user interface is further adapted to: send an identifier related to the financial instrument to the financial institution module, simultaneously receive values related to the identifier and to account information in the user account from the financial institution module, send trade data related to the identifier to the financial institution module, and simultaneously receive, from the financial institution module, at least one element from a group consisting of: a complete trade scenario based on the identifier, a portion of the values, the account information, the received trade data, and a portion of the complete trade scenario, a partially complete trade scenario based on the user's account information, and an incomplete trade scenario adapted to be completed based on receiving an input related to the incomplete trade scenario.

In a further embodiment, a computer readable medium comprises instructions for receiving an identifier related to a financial instrument, and simultaneously provides prices related to the received identifier, and a quantity of the financial instrument that can be traded related to at least one of the prices.

### BRIEF DESCRIPTION OF THE DRAWINGS

FIG. 1 illustrates a system for trading a financial instrument in accordance with an exemplary embodiment of the present invention;

FIG. 2 illustrates a complete stock trade graphical user interface in accordance with an exemplary embodiment of the present invention;

FIG. 3 illustrates a partially complete stock trade graphical user interface in accordance with an exemplary embodiment of the present invention;

FIG. 4 illustrates an incomplete stock trade graphical user interface in accordance with an exemplary embodiment of the present invention;

FIG. 5 illustrates a remaining balances portion of a graphical user interface in accordance with an exemplary embodiment of the present invention;

FIG. 6 illustrates an incomplete option trade graphical user interface in accordance with an exemplary embodiment of the present invention;

FIG. 7 illustrates an incomplete mutual fund trade graphical user interface in accordance with an exemplary embodiment of the present invention;

FIG. 8 illustrates an incomplete bond trade graphical user interface in accordance with an exemplary embodiment of the present invention;

FIG. 9 illustrates an alternate financial system graphical user interface in accordance with an exemplary embodiment of the present invention;

FIG. 10 illustrates a flow chart of a computer readable medium comprising instructions in accordance with an exemplary embodiment of the present invention;

FIG. 11 illustrates another flow chart of a computer readable medium comprising instructions in accordance with an exemplary embodiment of the present invention;

FIG. 12 illustrates a further flow chart of a computer readable medium comprising instructions in accordance with an exemplary embodiment of the present invention;

FIG. 13 illustrates yet another flow chart of a computer readable medium comprising instructions in accordance with an exemplary embodiment of the present invention; and

FIG. 14 illustrates yet a further flow chart of a computer readable medium comprising instructions in accordance with an exemplary embodiment of the present invention.

### DETAILED DESCRIPTION OF THE INVENTION

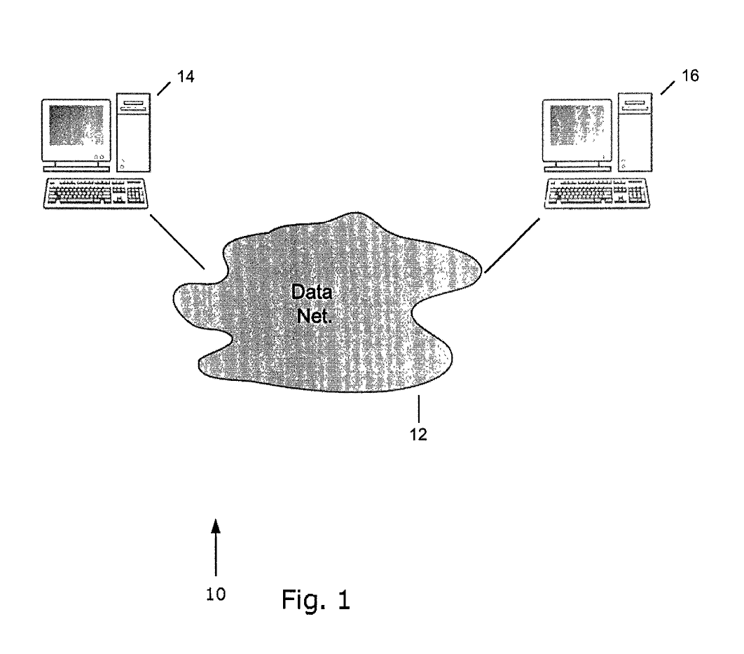

Referring now to FIG. 1, a system 10 is presented which includes a data network 12, such as the Internet, a client 14, such as a user's computer, and a server 16, such as an on-line broker's computer. Although not shown, a plurality of other clients, servers, and networks, such as wireless, voice and data networks, may be utilized with the system 10 of the present invention. A user (not shown) accesses information (or software) from the server 16 via the data network 12 and the client 14. The information may be utilized for providing financial instrument trading information and for trading a financial instrument in accordance to the present invention. The information may reside primarily on the server 16, may be distributed on a plurality of servers, may reside on the client 14, and/or may partially reside on the client and the server. It should also be noted that a variety of devices other than computers may be utilized as the client 14 and/or the server 16. Such other devices include, for example, a personal digital assistant, a mobile phone, a pager, a television, a land-line phone, an automatic teller machine, any combination of the above, and/or any device capable of transmitting and/or receiving analog and/or digital information. Further, the server 16 may be located on a broker's premise or hosted by another company.

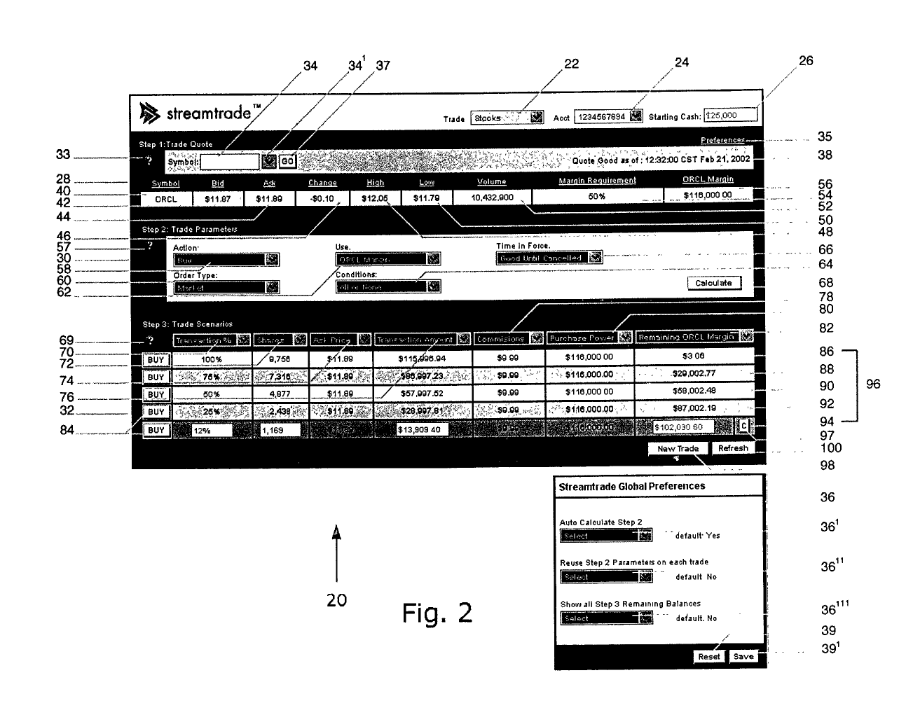

Referring now to FIG. 2, a graphical user interface (GUI) 20 is presented. The GUI 20 is accessed by and utilized by the user in a variety of ways. It should be noted that various other GUI's, such as a login page or a confirmation page, may be accessed by the user before or after the GUI 20 is accessed. Such other GUI's are not further described as they are well known in the art.

Upon logging into an on-line broker's web site, via, for example, the data network 12, the client 14, and the server 16, the GUI 20, comprising a plurality of fields, is presented to the user. The field 22 describes a type of financial instrument trade to be performed. As shown, a stock trade has been selected in the filed 22. Utilizing the pull-down menu (indicated by the down arrow near the field 22), other financial instruments can be chosen such as options, options, mutual funds, bonds, futures, currency, etc. Alternatively, a pull-up menu, a side-to-side menu, a voice recognition system, etc. can be used to select a financial instrument. The fields 24 and 26 respectively describe the user's account number and starting cash position. A pull-down menu associated with the account field 24 can be utilized to select other accounts a user may wish to access.

The GUI 20 contains three main portions which include a trade quote portion 28, a trade parameters portion 30, and a trade scenarios portion 32. These portions 28, 30, and 32, may simultaneously appear or may individually appear (either alone or together with a previous portion) when an action in a previous portion is complete. The trade quote portion 28 includes a help “button” 33 and a symbol field 34 which provides the user with the ability to input a symbol related to an equity. For example, if the user wishes to receive information about Oracle Corporation, the symbol “ORCL” would be input. It should be noted that various other input means may exist such as voice, voice to text, text to voice, etc. After the symbol is input, the user may press the “enter” key on a keyboard or keypad (not shown) coupled to the client 14 or may press the “GO button” 37 which results in the information contained in the fields 38-56. The pull-down menu 34′ associated with the symbol field 34 allows the user to view other stocks that are part of the user's portfolio. In an alternate embodiment, the user can also view all financial instrument positions that are part of the user's various accounts.

The fields 38-52 are well known in the art and include a time and date of the quote 38, the symbol 40, a bid price 42 (the highest price any buyer is willing to pay for a given security at a given time) of the symbol, an ask price 44 (the lowest price that any investor or dealer has declared for which a given security will be sold. For over-the-counter stocks, the ask is the best quoted price at which a Market Maker is willing to sell a stock. For mutual funds, the ask is the net asset value plus any sales charges.) of the symbol, a price change 46 (the difference between the price of a security at the close of market the previous trading day, and the current trading price) of the symbol, a high price 48 of the symbol thus far during a trading session, a low price 50 of the symbol thus far during the trading session, and a volume 52 (the number of shares, bonds or contracts traded during a given period for a security or an entire exchange) of the symbol.

The fields 54 and 56 respectively provide the user with information regarding the margin requirement of the specific equity (in this example, Oracle Corporation), and the margin purchase power available to the user to purchase the equity. The percentage contained in the margin maintenance requirement field 54 is security specific, is assigned by each brokerage, and typically varies between 25% and 100%, depending on the security. For example, a user wishes to purchase $1,000 of stock with a maintenance margin of 80%. This means that the user must have at least $800 of equity in his account (The account holder could borrow the remaining 20%). The margin requirement 54 of the equity is conveniently provided to the user so as to minimize the time the user would expend in searching for such information and to ensure that the information provided is correct. Currently, a user would have to find the margin requirements section of the online broker's web site, and calculate and/or decipher the information presented which may include: minimum equity requirements in general and for short sells, and option equity requirements for covered call options, equity spreads, short equity straddles, uncovered equity options, index spreads, short index straddles, and uncovered index options. Further margin requirements for bonds and potentially for mutual funds, may also need to be calculated and/or deciphered. The contents of the margin requirement field 54, along with other variables discussed below in relation to FIG. 16, are used to determine the margin purchase power of the equity.

The margin purchase power 56 describes the purchase power for the user's account as pertains to a specific security. The purchase power takes into account the user's excess margin, the security's margin maintenance requirement, Regulation T requirements, and other brokerage specific variables. Margin purchase power is defined as Excess Margin/Margin Requirement. For example, an account holder with $6,000 in excess margin wishes to purchase a stock with a 60% margin requirement. In this scenario, the account's margin purchase power would be $10,000. For stock purchases in the United States, it is important to keep in mind FASB Regulation T, which states that a account holder must currently have at least 50% margin requirement at the end of the day upon purchase of a stock. This means that the minimum margin requirement to be considered for a stock that will be held longer than one day is currently 50%.

The trade parameters portion 30 of the GUI 20 includes a help “button” 57, and the fields 58-66 which are well known in the art. The field 58 indicates a trading action the user may take and includes a pull-down menu listing the choices available to the user. As an example, the “buy” trading action is shown. By accessing the pull-down menu, other trading actions can be selected such as: sell, buy to open, buy to close, sell to open, and sell to close. The field 60 indicates an order type with a “market” order shown by example only. Other order types, accessed by the pull-down menu near the field 60 include: a limit order, a stop order, and a stop limit order. The field 62 indicates the method of payment for purchasing the equity which includes margin purchase power (denoted in the field 56), day trade/trading purchase power, and cash. The day trade purchase power applies to accounts set up specifically as day trading accounts. Day trading purchase power assumes the account needs a 25% margin requirement for purchases. The result is that the account could potentially purchase double what it could with a Regulation T requirement of 50%. The important consideration for the day trade purchase power is that the account must relinquish the position before the end of the trading day, otherwise the purchase will be subject to the Regulation T requirement, and the account could receive a margin call. The field 64 describes conditions for the trade which include, all or none, fill or kill, and, in the case of an options trade, covered, uncovered, spread, straddle, and strangle. The field 66 indicates the time in force the order type is to adhere to. A “good until cancelled” choice is presented by example only and, via the pull-down menu, a “good for the day” choice can be selected. If the order type was “market” then the field 66 would not appear.

Once the above fields have been selected, the calculate “button” 68 can be accessed in order to provide the trade or trading scenarios portion 32 of the GUI 20. The trade scenarios portion 32, which provides the user a plurality of trading scenarios based on a plurality of variables, includes a help “button” 69, and the fields 70-100. Some of these variables include a transaction percentage 70, a number of shares 72, a transaction amount 76, and a remaining margin 82. The transaction percentage 70 is based on the user's selection in the field 62. If the user selects cash, then the transaction percentage is based on total cash available for purchases. If the user selects day trade margin, then the transaction percentage is based on the total day trade margin purchase power available for purchases. If the user selects margin, then the transaction percentage is based on the total margin purchase power available for purchases. In the case of purchases or selling short, 100% means the user is using all his or her cash or margin to complete the transaction. For sales and buying to cover, 100% means the user is liquidating his or her entire position. The transaction percentage allows the user to see exactly how much they are about to buy or sell in relation to their entire account value or securities portfolio. This unique feature provides a plurality of trading information based on varying transaction percentages before a trade is placed. The transaction amount 76 represents the net value of the securities purchase or sale, including the brokerage commission. The remaining margin 82 describes the estimated amount of buying power (an account will contain after the user executes the current trade scenario.

The ask price field 74, the commissions field 78, and the purchase power field 80 typically cannot be altered by the user. However, the ask price field 74, for example, can be automatically updated as it changes. Such changes may also alter some of the “variable” fields such as the number of shares field 72 that can be purchased. Five complete trade scenarios 86-94 (collectively referred to as 96) are presented. It is noted that a lesser or greater number of trade scenarios may be presented as well as a lesser or greater number of fields in each trade scenario (i.e. some trade scenarios within the plurality of trade scenarios 96 may contain a different number of fields).

The trade scenario's 86-92 respectively provide trading information based on a 100% transaction percentage, a 75% transaction percentage, a 50% transaction percentage, and a 25% transaction percentage. By choosing one of the buy “buttons” 84, the user can initiate the desired trade based on the values in the fields 70-82. A sell “button” would appear if the sell action in the field 58 were chosen. Trade scenario 94 represents a complete trade scenario for a transaction percentage of 12%. This transaction percentage can be pre-selected in the user's personal account information and can be altered by the user. Further, the trade scenarios 96 can be represented based on the number of shares 72, the transaction amount 76, the remaining margin 82, or other remaining balances such as remaining cash, amount borrowed, etc.

The trade scenario 94 can be cleared via the clear “button” 97 which is depicted in the trade scenario 94 row by example only. If the trade scenario 94 fields are cleared, the user may input other values in the allowable fields 70, 72, 76, and 82. All of the fields in the GUI 20 can be cleared via the new trade “button” 98, while information contained in the fields 96 (and in any other field in GUI 20) that can be refreshed, are refreshed via the refresh “button” 100. Additional refreshable fields may include a most recent available bid price, ask price, high price, low price, and volume. As previously mentioned, such information may be “streamed” and provided in near real-time.

Choosing the preferences link 35, presents a global preferences window 36 (in any location on or near the GUI 20) that includes an auto calculate step 2 (trade parameters) field 36′, a reuse step 2 (trade) parameters on each trade field 36″, and a show all step 3 (trade scenario) remaining balances field 36′″. These global preferences (and others that are not shown) can be set by a user to customize the trading experience. For example, the auto calculate step 2 field 36′, whose default is yes, can automatically input information into the fields 58-66 and calculate the trade scenarios 96 without the user having to input the information and then choose the calculate “button” 68. Further, the reuse step 2 parameters on each trade field 36″, whose default is no, can allow the same step 2 parameters to be reused for each trade, while the show all step 3 remaining balances field 36′″, whose default is no, can show some of the remaining balances 70-82 for the trade scenarios 96. These preferences 36′, 36″, and 36′″ can be reset and/or saved by respectively choosing buttons 39 and 39′.

The above fields can further be pre-filled based on a user's preferences as indicated in the user's account information, based on past selections of the user, and/or based on current selections of the user. As the user is accessing certain fields and selecting or inputting choices into those fields, an error checking functionality ensures the quality of each choice. For example, if a user indicated a number of shares to be traded than was not possible because the user's account lacked the funds to do so, an error message explaining the situation would be presented. Also, a value or plurality of values can also be provided based on the funds in the user's account.

In one embodiment of the present invention, a method for providing financial instrument trading information comprises receiving an identifier related to the financial instrument. Such an identifier could be a ticker symbol 34 of an equity such as “ORCL,” the ticker symbol for Oracle Corporation. The method further comprises simultaneously providing values (such as the margin requirement 54 and the margin purchase power 56) related to the identifier and to a user's account information. The value's related to the user's account information include, for example, account balances, margin buying power, day trading buying power, positions owned, etc. The method further comprises receiving trade data (such as the information contained in the trade parameters portion 30) related to the identifier 34, and simultaneously providing at least one complete trade scenario 86-94, based on the identifier 34, a portion of the values (such as the margin purchase power 56), the user's account information, the received trade data, and a portion of the at least one trade scenario (such as the commission 78).

The method further comprises determining if the received trade data is acceptable and, if the received trade data is not acceptable (because of an error), providing at least one acceptable trade data, and receiving a trading command (such as buy, sell, sell short, limit, etc.) based on the simultaneously provided at least one complete trade scenario 86-94. The method also comprises providing prices (such as the bid 42, ask 44, high 48, low 50, etc.) and associated information (such as the change 46, volume 52, etc.) related to the identifier, updating the provided prices and the associated information based on a received command (such as a refresh command from the refresh “button” 100), and/or automatically updating the provided prices and the associated information (via streaming information), and updating the at least one complete trade scenario based on the provided prices and the associated information.

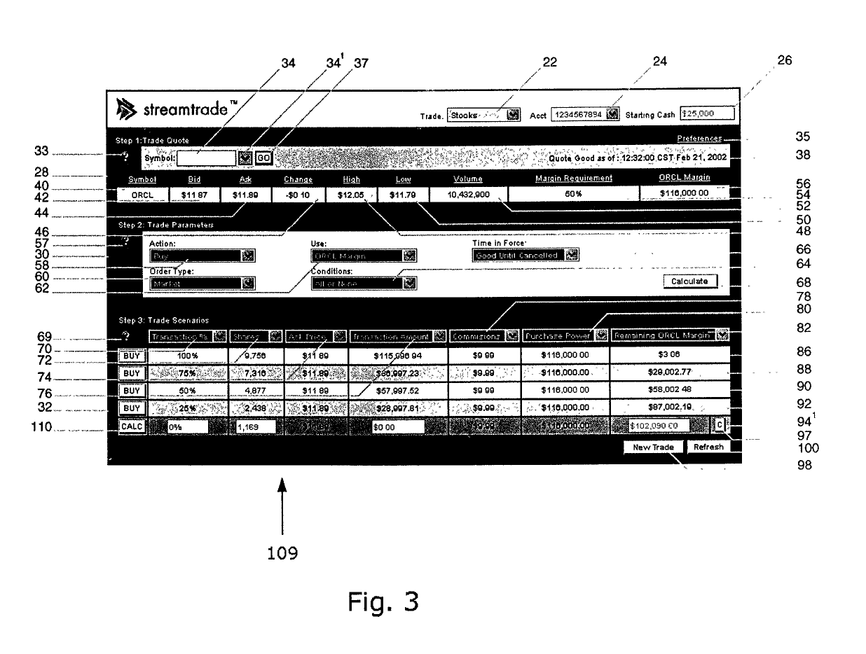

Referring now to FIG. 3, a GUI 109 is represented with a partially complete trade scenario 94′ which is simultaneously provided with the trade scenarios 86-92. The other fields and values in the GUI 109 are similar to those in the GUI 20. The partially complete trade scenario 94′ includes at lease one pre-set value from the fields 70, 72, 76, and 82. By example only, the transaction percentage field 70 includes a transaction percentage of 12%. The user can calculate, via the calc “button” 110, what values the remaining fields would have based on this transaction percentage. A different transaction percentage can be input or a value can be input into a different field (such as the shares field 72 independent of the transaction percentage) and the values of the remaining fields can be calculated. Once the calculation has been performed, the calc “button” 110 would be replaced by, per the action field 58, a buy “button” (not shown).

As such, a method exists for receiving an input related to the at least one partially complete trade scenario 94′, completing the at least one partially complete trade scenario based on the received input (for example the transaction percentage 70 of 12%), and providing at least one complete trade scenario based on the completing of the at least one partially complete trade scenario, wherein the at least one trade scenario is partially complete based on the user's account information. In an alternate embodiment, a trading command may be provided based on the at least one partially complete trade scenario 94′ (i.e., instead of the calc “button” 110, a “button” reflecting the trading command in the action field 58 would be presented).

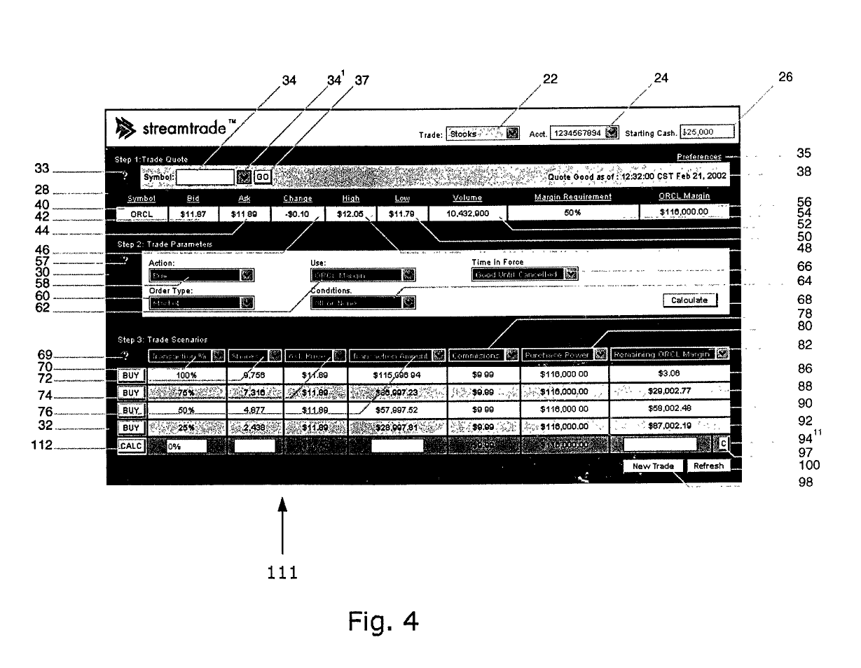

Referring now to FIG. 4, a GUI 111 is represented with an incomplete trade scenario 94″ which is simultaneously provided with the trade scenarios 86-92. The other fields and values in the GUI 111 are similar to those in the GUI 20. The incomplete trade scenario 94″ does not include any values from the fields 70, 72, and 76. A value can be input into either one of these fields 70, 72, and 76 (resulting in a partially complete trade scenario) and the user can calculate, via the calc “button” 112, what values the remaining fields would have (resulting in a complete trade scenario). Once the calculation has been performed, the calc “button” 112 would be replaced by, per the action field 58, a buy “button” (not shown).

As such, a method exists for receiving an input (such as the transaction percentage 70, the shares 72, the transaction amount 76, related to the at least one incomplete trade scenario 94″, completing the at least one partially complete trade scenario based on the received input (for example the transaction percentage 70 of 12%), providing at least one complete trade scenario based on the completing of the at least one incomplete trade scenario, and, in further embodiments, providing a trading command for the currently calculated at least one complete trade scenario, where the provided trading command is related to the received trade data such as the action field value 58. The received input is not related to a portion of the at least one trade scenario (such as the commission 78). If the use field 62 was filled with a cash choice, then the purchase power field 80 would display the amount of cash available for a trade.

The method further comprises receiving another input (either from the same or a different field 70, 72, 76) related to the at least one incomplete trade scenario 94″ after, for example, the clear “button” 98 is accessed, completing the at least one incomplete trade scenario based on the received other input, and providing at least one complete trade scenario based on the completing of the at least one incomplete trade scenario.

In another embodiment, a method for providing financial instrument trading information comprises receiving an identifier related to the financial instrument, simultaneously providing values related to the identifier and to a user's account information, receiving trade data related to the identifier, simultaneously providing at least one complete trade scenario based on the identifier, a portion of the values, the user's account information, the received trade data, and a portion of the at least one trade scenario, and receiving a trading command based on the simultaneously provided at least one complete trade scenario.

In a further embodiment, a method for providing financial instrument trading information comprises receiving an identifier related to the financial instrument, simultaneously providing values related to the identifier and to a user's account information, receiving trade data related to the identifier, simultaneously providing a plurality of completed trade scenarios, each scenario based on the identifier, a portion of the values, the user's account information, the received trade data, and a portion of each of the scenarios, wherein the scenarios are presented based on another portion of each of the scenarios.

In yet a further embodiment, a method for providing financial instrument trading information comprises receiving an identifier related to the financial instrument, simultaneously providing values related to the identifier and to a user's account information, receiving trade data related to the identifier, simultaneously providing at least one trade scenario from a group consisting of: a complete trade scenario based on the identifier, a portion of the values, the user's account information, the received trade data, and a portion of the at least one trade scenario, an incomplete trade scenario adapted to be completed based on receiving an input related to the at least one incomplete trade scenario, and a partially complete trade scenario adapted to be completed based on receiving an input related to the at least one incomplete trade scenario.

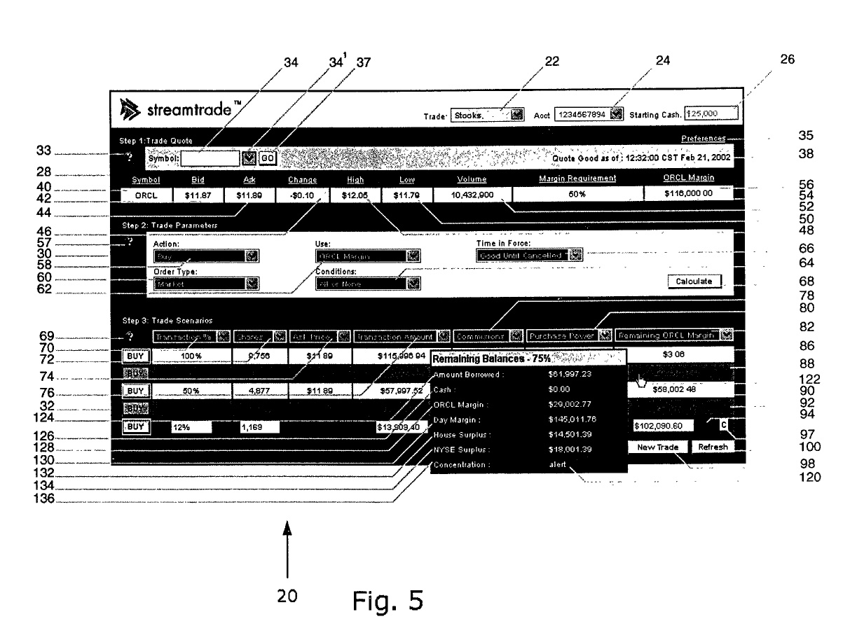

Referring now to FIG. 5, a remaining balances “pop-up” window 120 of the GUI 20 is presented. The window 120 appears when a cursor 122, is positioned over an area in the GUI and held there for an amount of time (usually for 1-3 seconds). By example only, the cursor 122 is positioned over the trade scenario 88. The resulting window 120 describes information related to a 75% transaction percentage and includes an amount borrowed value 124 (which is the estimated amount the account holder will have borrowed from the brokerage after the trade involving the 75% transaction percentage trade scenario), a cash value 126 (which is the estimated amount of cash in the user's brokerage account after a trade involving the 75% transaction percentage trade scenario), a remaining ORCL margin 128, a remaining day margin or remaining day trade purchase power 130 (which assumes the account needs only a 25% margin requirement for purchases), a remaining house call margin or remaining house surplus 132 (which is a measure of the excess margin an account contains over the required maintenance margins set by the brokerage), a remaining NYSE call margin or remaining NYSE surplus 134 (which is a measure of the excess margin contained in an account over the maintenance margins set by the NYSE), and a concentration alert value 136 (which tells the user whether the account could be designated a “concentrated” account by the margin board of the brokerage. Since concentrated accounts typically lack necessary diversity, they are subject to higher margin requirements, and are more likely to receive margin calls.).

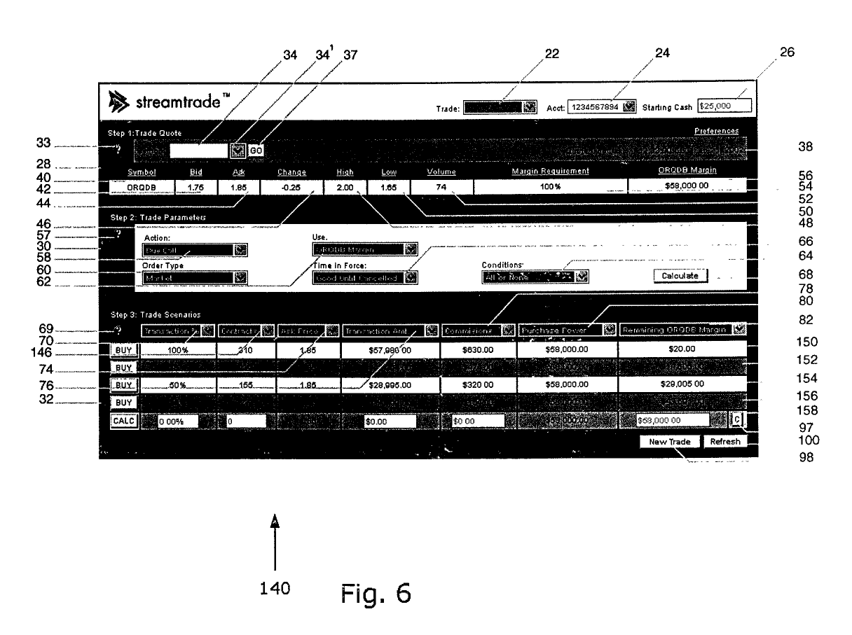

Referring now to FIG. 6, a GUI 140 representing an option trade is presented. If the user wishes to trade options, either before or after trading any other type of financial instrument, the options choice is selected within trade field 22. Similarly to the GUIs 20, 109, and 111, information is presented based on pre-set values, past user actions and/or current user actions. Various differences do exist, however. For example, an options symbol is input into the symbol field 34. Also, within the trade parameters portion, an action of buying a call (an option contract that gives the holder the right to buy the underlying stock at a specified price within a fixed period of time) or selling a put (an option contract that gives the holder the right to sell a certain quantity of an underlying security to the writer of the option, at a specified price (strike price) up to a specified date (expiration date)) can be chosen in the action field 58.

The order type field 60 choices include a market order, a limit order, a stop order, and a stop limit order. The market order is an instruction to buy or sell a security at the current bid or ask price when the order comes up for execution, the limit order is an instruction to buy a security at a specific price (or below), or to sell a security at (or above) a specific price, the stop order is designed to protect a profit or prevent further loss if the stock begins to move in the wrong direction (a stop order becomes a market order once the stock reaches a certain price), and the stop limit order is an order to buy or sell at a specified price or better (called a stop-limit price), but only after a given stop price has been reached or passed (it is a combination of a stop order and a limit order).

The use field 62 choices include cash, margin, or day trade margin. A cash choice tells the program that the user desires to see trade scenarios based on the assumption that no money will be borrowed on margin in order to complete the trade. This box only has relevance for purchases. A margin choice tells the program that the user desires to see trade scenarios where borrowing funds is an option. A day trade margin choice tells the program that the user desires to see trade where use of the day trade margin is possible.

The conditions field 64 choices include all or none or do not reduce. The all or none choice is a stipulation of an order which instructs the broker to either fill the whole order in one trade or not to fill it at all. The do not reduce choice is a feature of a buy or sell order instructing a broker not to decrease the limit price on buy-limit and sell-stop orders by the amount of a cash dividend on the ex-dividend date.

The time in force field 66 choices include a day order, a good until cancelled order, or a fill or kill order. The day order is an order that expires if it is not executed before the close of trading on the day it was entered or by the close of trading on the following market day, if the order was entered after market close. The good until cancelled order is an order to buy or sell that remains in effect until it is either executed or canceled (although brokers usually set a limit of 30 to 60 days, after which the broker will automatically cancel it or ask the customer if the order is to be kept active). The fill or kill order is an order given to a broker that must immediately be filled in its entirety or (if this is not possible) totally canceled.

Once the values for the fields in the GUI 140 are selected, the calculate “button” 68 can be accessed to provide the trade scenarios 150-158 which provide similar information to and can be manipulated similarly to the trade scenarios 86-94, 94′, and 94″ described above. It is noted that the contracts field 146 is used in place of the shares field 72, but similarly represents an amount of the financial instrument that can be traded.

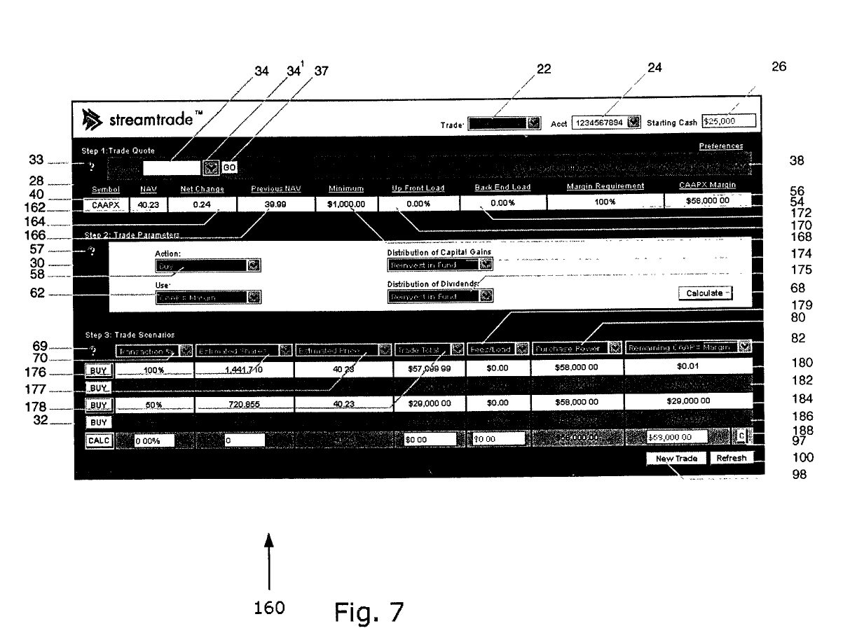

Referring now to FIG. 7, a GUI 160 representing a mutual fund trade is presented. If the user wishes to trade a mutual fund, either before or after trading any other type of financial instrument, the mutual fund choice is selected within trade field 22. Similarly to the GUIs 20, 109, 111, and 140, information is presented based on preset values, past user actions and/or current user actions. Various differences do exist, however. For example, a mutual fund symbol is input into the symbol field 34 and information relating to that symbol is presented such as a net asset value field 162, a net change field 164, a previous net asset value field 166, a minimum field 168, an up front load field 170, and a back end load field 172.

The net asset value field 162 denotes a dollar value of a single mutual fund share, based on the value of the underlying assets of the fund minus its liabilities, divided by the number of shares outstanding. Net asset value is calculated at the end of each business day. The net change field 164 describes the change in price of the mutual fund at the close of market on the previous trading day, and the price at the close of market at the current trading day. The previous net asset value field 166 denotes the previous dollar value of the single mutual fund share. The previous net asset value 166 plus the net change 164 equal the net asset value 162. The minimum field 168 states the minimum investment required to purchase shares in the mutual find, the up front load field 170 describes a sales charge or commission paid when an individual buys the mutual fund (limited partnership, annuity, insurance policy, or any other type of applicable investment) and a back end load field 172 which denotes a sales charge or commission paid when an individual sells the mutual fund which is intended to discourage withdrawals.

The action field 58 includes a buy or a sell choice. The use field 62 choices include cash, margin, or day trade margin. A cash choice tells the program that the user desires to see trade scenarios based on the assumption that no money will be borrowed on margin in order to complete the trade. This box only has relevance for purchases. A margin choice tells the program that the user desires to see trade scenarios where borrowing funds is an option. A day trade margin choice tells the program that the user desires to see a trade where use of the day trade margin is possible (although such a choice may not currently exist for mutual fund trading).

A distribution of capital gains field 174 describes where the user wishes to place any capital gains distributions from the mutual fund. The choices are reinvesting the distributions in the same mutual fund (which uses the dividends, interest, or profits from the mutual fund to buy additional shares of the fund), to place the distributions in a money market account, or to receive the distributions as cash. A distribution of dividends field 175 describes where the user wishes to place any dividend distributions from the mutual fund. The choices are reinvesting the distributions in the same mutual fund (which uses the dividends, interest, or profits from the mutual fund to buy additional shares of the fund), to place the distributions in a money market account, or to receive the distributions as cash.

Once the values for the fields in the GUI 160 are selected, the calculate “button” 68 can be accessed to provide the trade scenarios 180-188 which provide similar information to and can be manipulated similarly to the trade scenarios 86-94, 94′, 94″, and 150-158 described above. Various field changes do appear, however. For example, a value in the estimated shares field 176 describes the estimated number of shares that can be purchased based on the estimated price contained in the field 177. These values are estimated because most mutual fund prices are provided after the close of market trading. A trade total field 178 describes the estimated number of shares value 176 multiplied by the estimated price value, and a fees/load field 179 displays any fees or load associated with such a trade. If a user selects one of the trade scenarios for purchase, for example, the final price per share of that mutual fund would be used to calculate the number of shares that will be purchased.

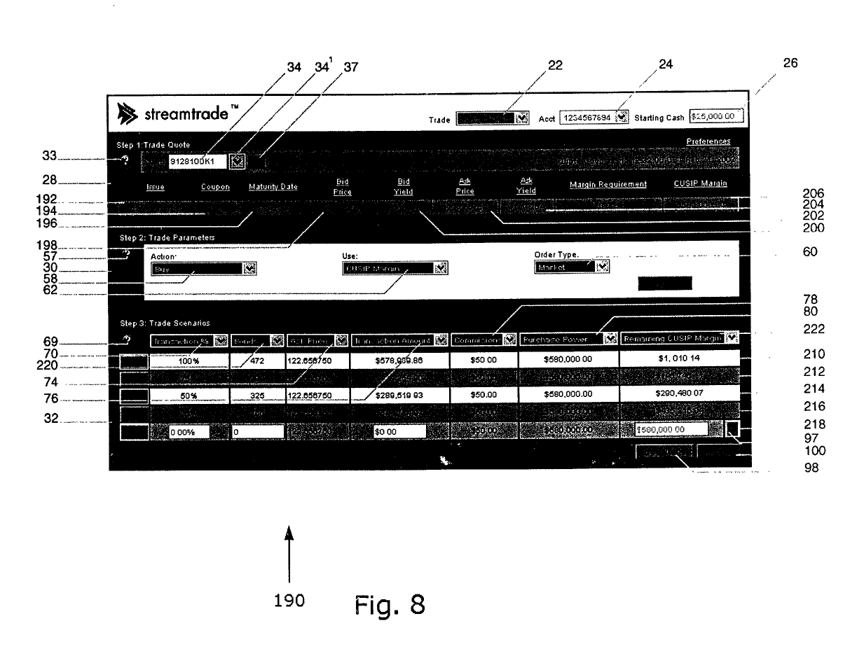

Referring now to FIG. 8, a GUI 190 representing a bond trade is presented. If the user wishes to trade a bond, either before or after trading any other type of financial instrument, the bond choice is selected within trade field 22. Similarly to the GUIs 20, 109, 111, 140, and 160, information is presented based on pre-set values, past user actions and/or current user actions. Various differences do exist, however. For example, a bond symbol is input into the symbol field 34 and information relating to that symbol is presented such as an issue field 192, a coupon field 194, a maturity date field 196, a bid price field 198, a bid yield field 200, an ask price field 202, an ask yield field 204 and a Committee on Uniform Securities and Identification Procedures (CUSIP) margin buying power field 206. A CUSIP number is a nine-character number that uniquely identifies a particular security (for example, the number 912810DK1 identifies the issue as a US Treasury N/9 bond. CUSIP is a standards body which created and maintains the classification system. Foreign securities have a similar number, called the CINS number.

The issue field 192 describes the type of bond the symbol represents. By example only, a U.S. Treasury bond is shown but other bonds, such as corporate and municipal bonds can be selected. Further, a bond can be chosen based on a bond rating such as AAA or junk. The coupon field 194 represents an interest amount to be paid to the bond holder. The coupons can be clipped as they come due and presented by the holder for payment of interest. Currently, while the term “coupon” is still sometimes used to refer to the interest payments on a bond, the physical possession of securities has been made obsolete by computers. The maturity date field 196 denotes the date that the bond comes due and must be paid off. The bid price field 198 and the bid yield field 200 represent the price and yield, respectively, that the bond can be purchased for. Bonds can be purchased based on price or yield. The ask price field 202 and the ask yield field 204 represent the price and yield, respectively, that the bond can be sold for. Bonds can be sold based on price or yield. The CUSIP margin buying power field 206 represents the buying power for a particular symbol.

The action field 58 includes a buy or a sell choice. The use field 62 choices include cash, margin, or day trade margin. A cash choice tells the program that the user desires to see trade scenarios based on the assumption that no money will be borrowed on margin in order to complete the trade. This box only has relevance for purchases. A margin choice tells the program that the user desires to see trade scenarios where borrowing funds is an option. A day trade margin choice tells the program that the user desires to see a trade where use of the day trade margin is possible (although such a choice may not currently exist for bond trading).

The order type field 60 includes a limit order, market order, yield order, or yield limit order, or stop limit order (previously described). The limit order is an instruction to buy a security at a specific price (or below), or to sell a security at (or above) a specific price while the market order is an instruction to buy or sell a security at the current bid or ask price when the order comes up for execution. The yield is an annual rate of return on an investment, expressed as a percentage. For bonds and notes, the yield is the coupon rate divided by the market price (for securities, yield is the annual dividends divided by the purchase price). The yield limit is the lowest annual yield at which a trader is willing to buy bills, or the highest yield at which the trader is willing to sell bills (this typically occurs when placing an order to buy or sell Treasury bills).

Once the values for the fields in the GUI 190 are selected, the calculate “button” 68 can be accessed to provide the trade scenarios 210-218 which provide similar information to and can be manipulated similarly to the trade scenarios 86-94, 94′, 94″, 150-158, and 180-188 described above. Various field changes do appear, however. For example, a value in the bonds field 220 describes an amount of bonds to be traded while a value in the remaining CUSIP margin field 222 denotes the remaining available CUSIP margin.

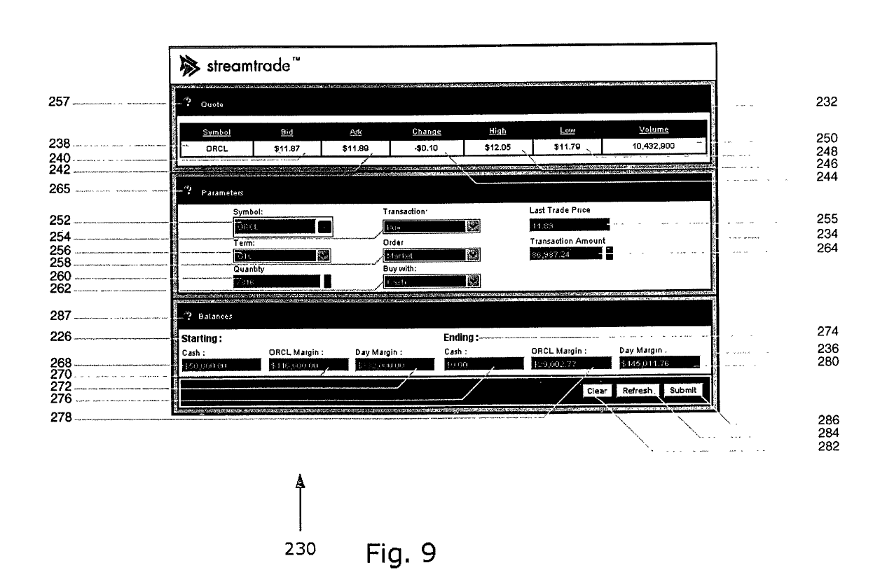

Referring now to FIG. 9 a GUI 230 is presented which provides a user with an alternate manner in which to receive financial instrument trading information and for trading the financial instrument. The GUI 230 includes a quote portion 232, a parameters portion 234, and a balances portion 236. The quote portion 232 includes a symbol field 238, a bid field 240, an ask field 242, a change field 244, a high field 246, a low field 248, a volume field 250, and a help “button” 251.

The parameters portion 234 includes a symbol field 252, a transaction (or action) field 254, a last trade price field 255, a term field 256, an order (or order type) field 258, a quantity field 260, a buy with (or use) field 262, and a transaction amount field 264. When a symbol is input in the symbol field 252, the information in the quote portion 232 and information in the quantity field 260 simultaneously appear. Additionally, information in the order type field 258, and the transaction amount field 264 may also simultaneously appear. If the order type is chosen as a limit order, for example, a limit field 259 will appear for the user to input a limit price. This limit field 259 will not appear if a market order has been selected and is depicted on the GUI 230 for clarity. The last price field 255 indicates the last price the financial instrument traded at and may or may not be identical to the current bid or ask prices. The time in force field 256 choice and the use field 262 choice can be chosen based on the user's preferences or pre-set values. As such, the user can receive information regarding a quantity of shares that can be purchased by merely inputting the symbol. Additionally, a help “button” 265 can be accessed. It should be understood that the stock symbol in fields 238 and 252 is used as an example only and that other financial instruments may be traded using the GUI 230.

The balances portion 236 includes a starting cash area 266 and an ending cash area 274 which respectively include cash fields 268 and 276, margin (or buying power) fields 270 and 278, and day margin (or day trading purchase power) fields 270 and 280. These balances fields, which provide the user with starting values 268-272 before a trade is executed and which further provide the user with ending values 276-280 after the trade would be executed, may similarly simultaneously appear when a symbol is input and received by the software residing on the client 14 and/or the server 16. As such, the user can determine if the ending values 276-280 are appropriate before a trade is placed via the submit “button” 286. The clear “button” 282, the refresh “button” 284, and the help “button” 287 are all used in a similar manner as described above.

In one embodiment of the present invention, a method for providing financial instrument trading information comprises receiving an identifier related to the financial instrument, and simultaneously providing prices related to the received identifier and a quantity of the financial instrument that can be traded related to at least one of the prices. The method continues by simultaneously providing: trading parameters that include the quantity that can be traded, a starting balance based on the trading parameters, where the starting balance is provided prior to a trade occurring, and an ending balance based on the trading parameters, where the ending balance is provided prior to a trade occurring. The method further comprises providing an ability to trade the quantity, where the quantity that can be traded is further related to at least one of the following elements from a group consisting of: margin purchase power, day trading power (or day trading purchase power), available cash, financial instrument buying power, financial instrument margin requirement, and a commission.

In another embodiment of the present invention, a method for providing financial instrument trading information comprises receiving an identifier related to the financial instrument, and simultaneously providing: trading parameters including a quantity that can be traded, a starting balance based on the trading parameters, where the starting balance is provided prior to a trade occurring, and an ending balance based on the trading parameters, where the ending balance is provided prior to the trade occurring. The starting and ending balances comprise at least one of the following elements from a group consisting of: a cash balance, a buying power of the financial instrument, and a day trading power.

In order to produce some of the trade scenarios described above, the software receives an identifier and trade data related to a financial instrument and provides a plurality of trade scenarios based on the received trade data and a result. The result is based on a first amount divided by a second amount, wherein the first amount is based on a sum of available cash minus a commission, and a trading percentage multiplied by the sum, and wherein the second amount is based on a trading price of the identifier.

For an alternate result, a first amount is divided by a second amount, wherein the first amount is based on a sum of a margin purchase power multiplied by a margin requirement percentage, minus a commission, and a trading percentage multiplied by the sum, and wherein the second amount is based on a trading price of the identifier.

As previously mentioned the software for providing financial instrument trading information is accessed by the user to receive important, near real-time information before a trade is placed. A system for handling such a trade comprises a financial institution server (which may be located on the financial institution's premise and/or off premise) which stores a user account and all related information. A user interface (such as the client 14 or server 16), used to access the user account, is further utilized to: send an identifier related to the financial instrument to the financial institution server, simultaneously receive values related to the identifier and to account information in the user account from the financial institution server, send trade data related to the identifier to the financial institution server, and simultaneously receive, from the financial institution server, one or more trade scenarios including a complete trade scenario (described in FIG. 2), a partially complete trade scenario (described in FIG. 3), and an incomplete trade scenario (described in FIG. 4).

In an alternate embodiment, a server may receive an identifier related to a financial instrument, simultaneously send values related to the identifier and to account information, receive trade data related to the identifier, and based on the received trade data, simultaneously send a complete trade scenario, a partially complete trade scenario, and/or an incomplete trade scenario.

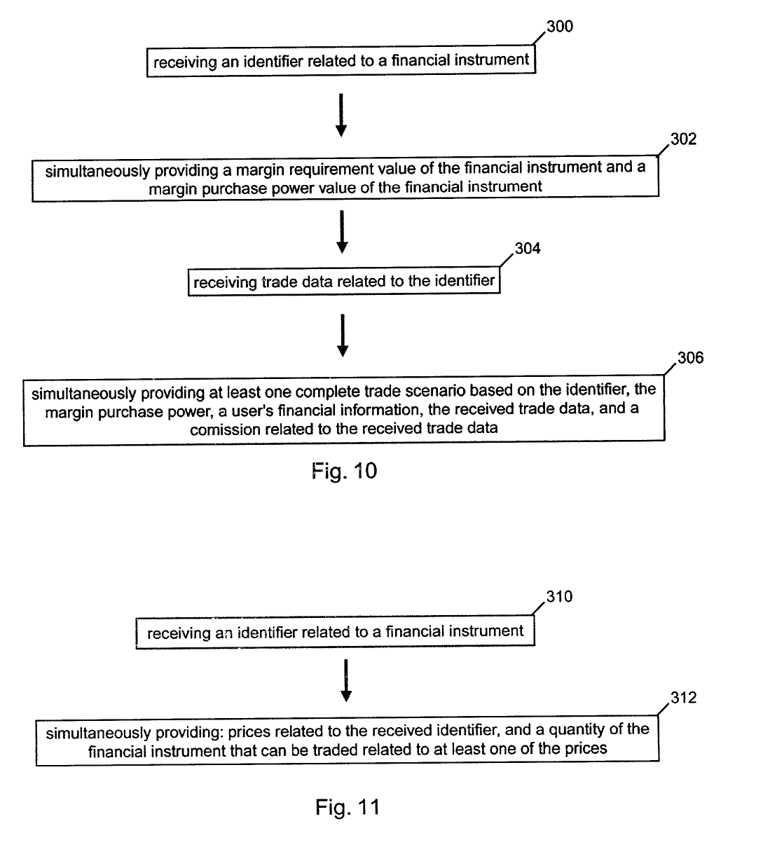

Referring now to FIG. 10, a flow chart describing a computer readable medium, or software, instructions is presented. Such instructions are used for receiving an identifier related to a financial instrument at step 300, simultaneously providing a margin requirement value of the financial instrument and a margin purchase power value of the financial instrument at step 302, receiving trade data related to the identifier at step 304, and simultaneously providing at least one complete trade scenario based on the identifier, the margin purchase power, a user's financial information, the received trade data, and a commission related to the received trade data at step 306.

Referring now to FIG. 11, another flow chart describing a computer readable medium, or software, instructions is presented. Such instructions are used for receiving an identifier related to a financial instrument at step 310, and simultaneously provides prices related to the received identifier, and a quantity of the financial instrument that can be traded related to at least one of the prices at step 312.

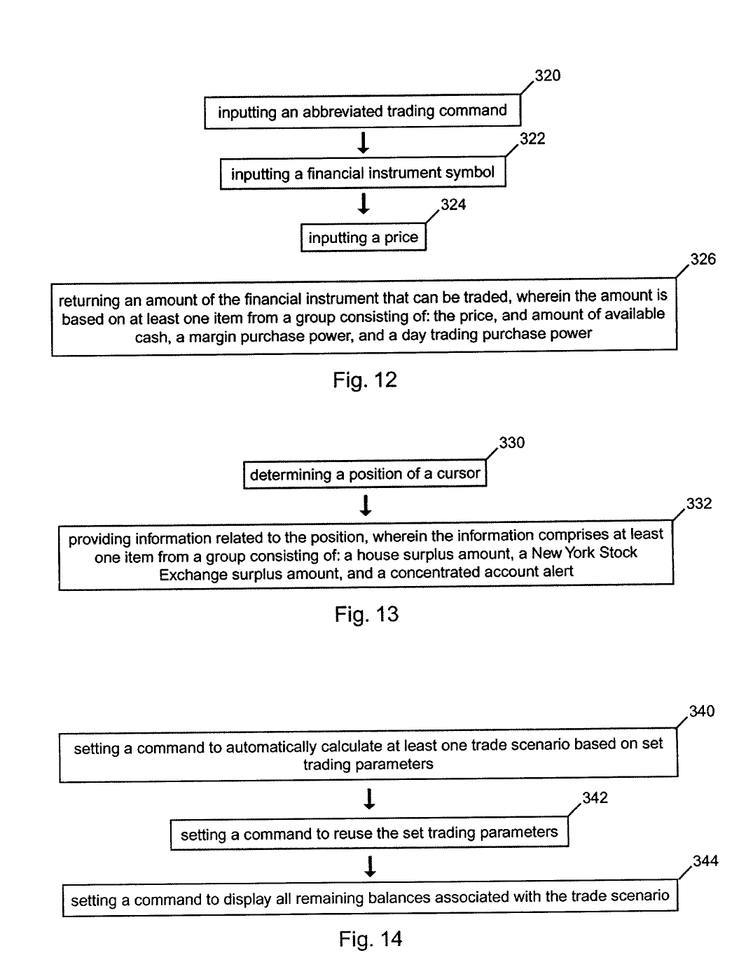

Referring now to FIG. 12, a further flow chart describing a computer readable medium, or software, instructions is presented. Such instructions are used for inputting an abbreviated trading command (such as a “b” for a buy or an “s” for a sell) at step 320, inputting a financial instrument symbol at step 322, inputting a price at step 324, and, at step 326, returning an amount of the financial instrument that can be traded, wherein the amount is based on at least one item from a group consisting of: the price, an amount of available cash, a margin purchase power, and a day trading purchase power. Further instructions may be used for inputting an order type which may be abbreviated (for example, a market order can be denoted with the letter “m” and a limit order can be denoted with the letter “l”), and inputting a transaction percentage which may be abbreviated (for example, a 100% transaction percentage may be denoted by the word “max” or “all”). Also instructions can be used for inputting an abbreviated financial instrument symbol (for example, to trade the stock of Oracle Corporation, the letters “OR” can be used instead of the entire current symbol (ORCL)).

Referring now to FIG. 13, yet another flow chart describing a computer readable medium, or software, instructions is presented. Such instructions are used for determining a position of a cursor at step 330, and, at step 332, providing information related to the position, wherein the information comprises at least one item from a group consisting of a house surplus amount, a New York Stock Exchange surplus amount, and a concentrated account alert. Such information, which may be presented, for example, on a “pop-up” window that appears after a cursor has been positioned over an area for a predetermined amount of time, further comprises at least one item from a group consisting of a borrowed amount, a cash amount, a financial instrument margin amount, and a day trading margin amount.

Referring now to FIG. 14, yet a further flow chart describing a computer readable medium, or software, instructions is presented. Such instructions are used for setting a command to automatically calculate at least one trade scenario based on set trading parameters at step 340, setting a command to reuse the set trading parameters at step 342, and, at step 344, setting a command to display all remaining balances associated with the trade scenario.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, if a user inputs a bond symbol in a GUI chosen for stock trades, the software automatically provides a GUI chosen for bond trades, with the bond symbol and relevant information already displayed. Also, based on user preferences and past actions, certain steps can be skipped. For example, the calculate button 68 may not have to be chosen in order for a calculation to occur and can occur after a user has inputted choices in various fields (for example, after the fields in the trade parameters portion 30 are chosen, a calculation is automatically performed) or after a certain time has expired (for example, 4 seconds after the fields in the trade parameters portion 30 are chosen, or 8 seconds after no fields are chosen—i.e. the user may accept the default choices—the calculation is automatically performed).

Further, the pull-down menus may include pull-up menus, and sideways menus which may provide similar or different information. For example, a pull-up menu could provide charting and graphing information selections relating to a stock, a left menu could provide recent news and related link information selections relating to the stock, and a right menu could provide information related to a users trading history for the particular stock.

Also, various other user financial accounts, such as checking accounts, savings accounts, money market accounts, certificates of deposit, and other brokerage accounts may be linked to the present invention to provide a differing, and preferably greater, range of choices for the user. For example, the user may be able to increase a purchase power if additional funds from another account were taken into consideration. Such flexibility may be highly desired. Still further, an action to buy a certain financial instrument may be initiated if the user does not currently own the instrument and inputs the related symbol fields 34 and 252. Conversely, an action to sell a certain financial instrument may be initiated if the user currently owns the instrument and inputs the related symbol fields 34 and 252. Other considerations such as an amount to buy or sell, an order type, conditions, etc. may be pre-selected.

What we claim is:

1. A method for providing financial instrument trading information, the method comprising:
receiving an identifier related to the financial instrument;
simultaneously providing values related to the identifier and to a user's account information;
receiving trade data related to the identifier; and
simultaneously providing at least one complete trade scenario based on the identifier, a portion of the values, the user's account information, the received trade data, and a portion of the at least one trade scenario.

2. The method of claim 1 further comprising:
determining if the received trade data is acceptable; and
if the received trade data is not acceptable, providing at least one acceptable trade data.

3. The method of claim 1 further comprising receiving a trading command based on the simultaneously provided at least one complete trade scenario.

4. The method of claim 1 further comprising simultaneously providing at least one incomplete trade scenario.

5. The method of claim 4 further comprising receiving an input related to the at least one incomplete trade scenario.

6. The method of claim 5 further comprising:
completing the at least one incomplete trade scenario based on the received input; and
providing at least one complete trade scenario based on the completing of the at least one incomplete trade scenario.

7. The method of claim 6 further comprising providing a trading command for the at least one complete trade scenario, wherein the provided trading command is related to the received trade data.

8. The method of claim 4 further comprising:
receiving another input related to the at least one incomplete trade scenario;
completing the at least one incomplete trade scenario based on the received other input; and
providing at least one complete trade scenario based on the completing of the at least one incomplete trade scenario.

9. The method of claim 5, wherein the received input is not related to the portion of the at least one trade scenario.

10. The method of claim 1 further comprising simultaneously providing at least one partially complete trade scenario.

11. The method of claim 10 further comprising providing a trading command based on the at least one partially complete trade scenario.

12. The method of claim 10 further comprising:
receiving an input related to the at least one partially complete trade scenario;
completing the at least one partially complete trade scenario based on the received input; and
providing at least one complete trade scenario based on the completing of the at least one partially complete trade scenario.

13. The method of claim 10 wherein the at least one trade scenario is partially complete based on the user's account information.

14. The method of claim 1 further comprising providing prices and associated information related to the identifier.

15. The method of claim 14 further comprising at least one of a following action from a group consisting of:
updating the provided prices and the associated information based on a received command; and
automatically updating the provided prices and the associated information.

16. The method of claim 15 further comprising updating the at least one complete trade scenario based on the provided prices and the associated information.

17. A method for providing financial instrument trading information, the method comprising:
receiving an identifier related to the financial instrument;
simultaneously providing values related to the identifier and to a user's account information;
receiving trade data related to the identifier;
simultaneously providing at least one complete trade scenario based on the identifier, a portion of the values, the user's account information, the received trade data, and a portion of the at least one trade scenario; and
receiving a trading command based on the simultaneously provided at least one complete trade scenario.

18. A method for providing financial instrument trading information, the method comprising:
receiving an identifier related to the financial instrument;
simultaneously providing values related to the identifier and to a user's account information;
receiving trade data related to the identifier; and
simultaneously providing a plurality of completed trade scenarios, each scenario based on the identifier, a portion of the values, the user's account information, the received trade data, and a portion of each of the scenarios, wherein the scenarios are presented based on another portion of each of the scenarios.

19. A method for providing financial instrument trading information, the method comprising:
receiving an identifier related to the financial instrument;
simultaneously providing values related to the identifier and to a user's account information;
receiving trade data related to the identifier; and
simultaneously providing at least one trade scenario from a group consisting of:
a complete trade scenario based on the identifier, a portion of the values, the user's account information, the received trade data, and a portion of the at least one trade scenario;
an incomplete trade scenario adapted to be completed based on receiving an input related to the at least one incomplete trade scenario; and
a partially complete trade scenario adapted to be completed based on receiving an input related to the at least one incomplete trade scenario.

20. A method for providing financial instrument trading information, the method comprising:
receiving an identifier related to the financial instrument; and
simultaneously providing:
prices related to the received identifier; and
a quantity of the financial instrument that can be traded related to at least one of the prices.

21. The method of claim 20 further comprising simultaneously providing trading parameters that include the quantity that can be traded.

22. The method of claim 21 further comprising simultaneously providing a starting balance based on the trading parameters, wherein the starting balance is provided prior to a trade occurring.

23. The method of claim 21 further comprising simultaneously providing an ending balance based on the trading parameters, wherein the ending balance is provided prior to a trade occurring.

24. The method of claim 20 further comprising providing an ability to trade the quantity.

25. The method of claim 20 wherein the quantity that can be traded is further related to at least one of a following element from a group consisting of:
margin purchase power;
day trading power;
available cash;
financial instrument buying power;
financial instrument margin requirement; and
commission.

26. A method for providing financial instrument trading information, the method comprising:
receiving an identifier related to the financial instrument; and
simultaneously providing:
trading parameters including a quantity that can be traded;
a starting balance based on the trading parameters, wherein the starting balance is provided prior to a trade occurring; and
an ending balance based on the trading parameters, wherein the ending balance is provided prior to the trade occurring.

27. The method of claim 26 wherein the starting balance comprises at least one of a following element from a group consisting of:
a starting cash balance;
a starting buying power of the financial instrument; and
a starting day trading power.

28. The method of claim 26 wherein the ending balance comprises at least one of a following element from a group consisting of:
an ending cash balance;
an ending buying power of the financial instrument; and
an ending day trading power.

29. A method for trading a financial instrument, the method comprising:
providing, by a user, an identifier related to the financial instrument;
simultaneously receiving values related to the identifier and to account information related to the user;
providing, by the user, trade data related to the identifier; and
simultaneously receiving at least one complete trade scenario based on the identifier, a portion of the values, the user's account information, the received trade data, and a portion of the at least one trade scenario.

30. A method for producing a trading scenario, the method comprising:
receiving an identifier related to a financial instrument;
receiving trade data related to the identifier; and
providing a plurality of trade scenarios based on:
the received trade data; and
a result, wherein the result is based on a first amount divided by a second amount, wherein the first amount is based on a sum of available cash minus a commission, and a trading percentage multiplied by the sum, and wherein the second amount is based on a trading price of the identifier.

31. A method for producing a trading scenario, the method comprising:
receiving an identifier related to a financial instrument;
receiving trade data related to the identifier; and
providing a plurality of trade scenarios based on:
the received trade data; and
a result, wherein the result is based on a first amount divided by a second amount, wherein the first amount is based on a sum of a margin purchase power multiplied by a margin requirement percentage, minus a commission, and a trading percentage multiplied by the sum, and wherein the second amount is based on a trading price of the identifier.

32. A system for trading a financial instrument, the system comprising:
a financial institution server;
a user account located at the financial institution server;
a user interface adapted to access the user account, wherein the user interface is further adapted to:
send an identifier related to the financial instrument to the financial institution server;
simultaneously receive values related to the identifier and to account information in the user account from the financial institution server;
send trade data related to the identifier to the financial institution server; and
simultaneously receive, from the financial institution server, at least one element from a group consisting of:
a complete trade scenario based on the identifier, a portion of the values, the user's account information, the received trade data, and a portion of the complete trade scenario;
a partially complete trade scenario based on the user's account information; and
an incomplete trade scenario adapted to be completed based on receiving an input related to the incomplete trade scenario.

33. A server adapted to:
receive an identifier related to a financial instrument;
simultaneously send values related to the identifier and to account information;
receive trade data related to the identifier; and
based on the received trade data, simultaneously send at least one element from a group consisting of:
a complete trade scenario based on the identifier, a portion of the values, the account information, the received trade data, and a portion of the complete trade scenario;
a partially complete trade scenario based on the user's account information; and
an incomplete trade scenario adapted to be completed based on receiving an input related to the incomplete trade scenario.

34. A computer readable medium comprising instructions for:
receiving an identifier related to a financial instrument;
simultaneously providing a margin requirement value of the financial instrument and a margin purchase power value of the financial instrument;
receiving trade data related to the identifier; and
simultaneously providing at least one complete trade scenario based on the identifier, the margin purchase power, a user's financial information, the received trade data, and a commission related to the received trade data.

35. A computer readable medium comprising instructions for:
receiving an identifier related to a financial instrument; and
simultaneously providing:
prices related to the received identifier; and
a quantity of the financial instrument that can be traded related to at least one of the prices.

36. A computer readable medium comprising instructions for:
inputting an abbreviated trading command;
inputting a financial instrument symbol;
inputting a price; and
returning an amount of the financial instrument that can be traded, wherein the amount is based on at least one item from a group consisting of:
the price;
an amount of available cash;
a margin purchase power; and
a day trading purchase power.

37. The computer readable medium of claim 36 further comprising instructions for inputting an order type, wherein the order type is abbreviated.

38. The computer readable medium of claim 36 further comprising instructions for inputting a transaction percentage, wherein the transaction percentage is abbreviated.

39. The computer readable medium of claim 36 further comprising instructions for inputting an abbreviated financial instrument symbol.

40. A computer readable medium comprising instructions for:
determining a position of a cursor; and
providing information related to the position, wherein the information comprises at least one item from a group consisting of:
a house surplus amount;
a New York Stock Exchange surplus amount; and
a concentrated account alert.

41. The computer readable medium of claim 40, wherein the information further comprises at least one item from a group consisting of:
a borrowed amount;
a cash amount;
a financial instrument margin amount; and
a day trading margin amount.

42. A computer readable medium comprising instructions for:
setting a command to automatically calculate at least one trade scenario based on set trading parameters;
setting a command to reuse the set trading parameters; and
setting a command to display all remaining balances associated with the trade scenario.
